(19) United States
(12) Patent Application Publication
(10) Pub. No.: US 2013/0141415 A1
(43) Pub. Date: Jun. 6, 2013

(54) Apparatus and method for adjusting a battery voltage level output in a portable terminal

(71) Applicant: Samsung Electronics Co., Ltd., Gyeonggi-do (KR)

(72) Inventor: Jin-Kyu Kim, Daegu (KR)

(73) Assignee: Samsung Electronics Co., Ltd., Gyeonggi-do (KR)

(21) Appl. No.: 13/694,179

(22) Filed: Oct. 31, 2012

(30) Foreign Application Priority Data
Oct. 31, 2011 (KR) 10-2011-0112066

(51) Int. Cl. G09G 3/32

(52) U.S. Cl. CPC G09G 3/3208
USPC 345/212; 345/76

(57) ABSTRACT

A method and apparatus for performing compensation to adjust a battery voltage level output in a portable terminal without incorporating a dedicated battery gauge integrated circuit may include: calculating a color rate of an image when the image is output on an active matrix organic light-emitting diode (AMOLED), determining a current battery voltage value, performing compensation to adjust a battery voltage value based on the color rate of the image and the current battery voltage value, and displaying a battery residual quantity icon indicating a residual quantity of a battery based on the adjusted battery voltage value.

### CLAIM OF PRIORITY

This application claims the priority under 35 U.S.C. §119(a) of an application entitled “Apparatus And Method For Performing Compensation To Adjust A Battery Voltage In Portable Terminal” filed in the Korean Intellectual Property Office on Oct. 31, 2011 and assigned Serial No. 10-2011-0112066, the contents of which are hereby incorporated by reference.

### BACKGROUND OF THE INVENTION

1. Field of the Invention

The present invention relates to a portable terminal, and more particularly, to an apparatus and method for performing an adjustment of a battery voltage level output in a portable terminal.

2. Description of the Related Art

As communication technologies have developed, demands for better image display have increased. Due to this demand, devices displaying an image have been increasingly replaced by active matrix organic light-emitting diode (AMOLED). The AMOLED may provide a relatively constant color reproducibility, brightness, and contrast ratio even in a bright setting when compared to a conventional liquid crystal display (LCD) device.

However, the AMOLED consumes a different amount of current for each color as each pixel is its own light source. Thus, a battery compensation algorithm for colors may not be applicable in terms of software. That is, the color of a currently output image may not be recognized in terms of software. As such, all portable terminals equipped with the AMOLED may need to include a dedicated gauge integrated circuit (IC) chip, i.e., for battery-monitoring gauge IC, to gauge a battery.

However, the proposal for the gauge IC chip may have a drawback in that a production cost is high and containing the dedicated gauge IC chip in the portable terminal is difficult.

Accordingly, there is a need for improved ways to measure battery current and voltage to determine state-of-charge.

### SUMMARY OF THE INVENTION

Accordingly, an aspect of the present invention is to solve the above-mentioned problems occurring in the prior art, by providing a method and apparatus for performing compensation to adjust a battery voltage associated with a color to indicate remaining battery capacity, without using a dedicated gauge integrated circuit (IC).

In accordance with an aspect of the present invention, a battery voltage compensation apparatus for performing compensation to adjust a battery voltage to indicate a residual quantity of the battery of a portable terminal includes: a display unit including an active matrix organic light-emitting diode (AMOLED) that displays an image, and calculating a color rate of the image, a battery to output a current battery voltage value at predetermined intervals, and a controller to receive the color rate of the image and the current battery voltage value when the image is displayed, to perform compensation to adjust a battery voltage value based on the current battery voltage value, and to change a battery residual quantity icon indicating the residual quantity of the battery based on the adjusted battery voltage value.

In accordance with another aspect of the present invention, a battery voltage compensation method for performing compensation to adjust a battery voltage to indicate a residual quantity of the battery of a portable terminal includes: calculating a color rate of an image when the image is output on an active matrix organic light-emitting diode (AMOLED), determining a current battery voltage value, performing compensation to adjust a battery voltage value based on the color rate of the image and the current battery voltage value, and changing a battery residual quantity icon indicating the residual quantity of a battery based on the adjusted battery voltage value.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating a portable terminal according to an exemplary embodiment of the present invention;

FIG. 2 is a block diagram illustrating a display unit according to an exemplary embodiment of the present invention;

FIG. 3 is a flowchart illustrating a method of performing compensation to adjust a battery voltage to indicate a residual quality of the battery of a portable terminal according to a first exemplary embodiment of the present invention; and

FIG. 4 is a flowchart illustrating a method of performing compensation to adjust a battery voltage to indicate a residual quality of the battery of a portable terminal according to a second exemplary embodiment of the present invention.

### DETAILED DESCRIPTION

Hereinafter, exemplary embodiments of the present invention will be described with reference to the accompanying drawings. In the following description, the same elements will be designated by the same reference numerals although they are shown in different drawings. Also, various specific definitions found in the following description, such as specific values of packet identifications, contents of displayed information, etc., are provided only to help general understanding of the present invention, and it is apparent to those skilled in the art that the present invention can be implemented without such definitions. Further, for the purposes of clarity and simplicity, a detailed description of known functions and configurations incorporated herein will be omitted as it may make the subject matter of the present invention unclear.

A portable terminal according to exemplary embodiments may be a portable electronic device, for example, a videophone, a portable phone, a smart phone, an International Mobile Telecommunication 2000 (IMT-2000) terminal, a Wideband Code Division Multiple Access (WCDMA) terminal, a Universal Mobile Telecommunication Service (UMTS) terminal, a Personal Digital Assistance (PDA), a Portable Multimedia Player (PMP), a Digital Multimedia Broadcasting (DMB) terminal, any duplex communication devices, an E-book, portable computers including a notebook, a tablet, and the like.

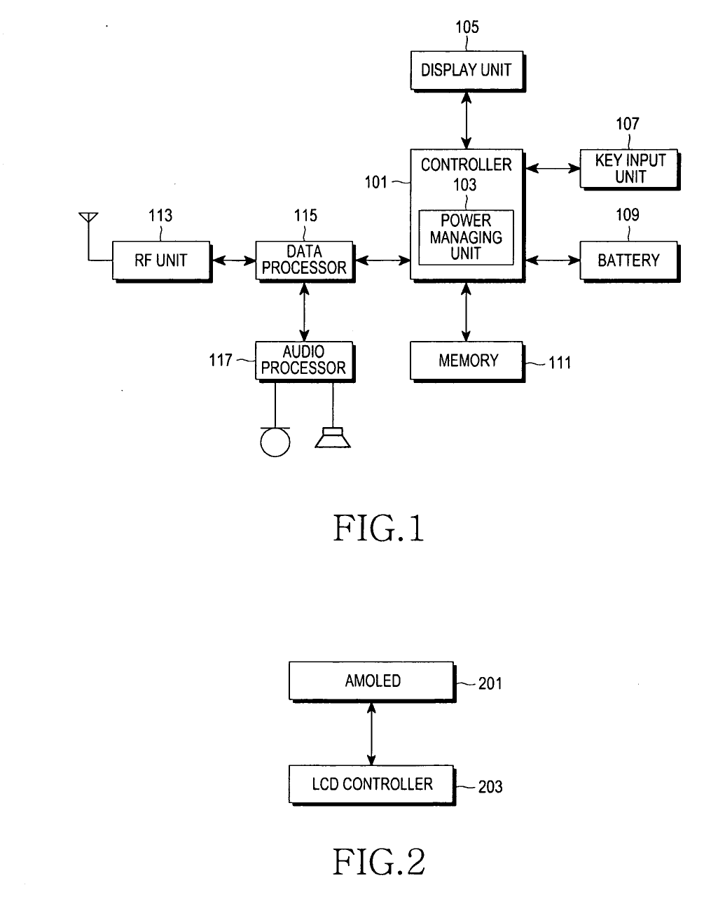

FIG. 1 illustrates a portable terminal according to an exemplary embodiment of the present invention. FIG. 2 illustrates a display unit according to an exemplary embodiment of the present invention.

Referring to FIG. 1, the portable terminal may include a controller 101, a display unit 105, a key input unit 107, a battery 109, a memory 111, an audio processing unit 117, a radio frequency (RF) unit 113, and a data processing unit 115.

In operation, the RF unit 113 may perform a radio communication function of the portable terminal. In particular, the RF unit 113 may include a wireless transmitter to perform up-conversion and amplification of a frequency of a transmitted signal, a wireless receiver to perform low noise amplification of a received signal and low-conversion of a frequency, and the like. The data processing unit 115 may include a transmitter to encode and modulate a transmitted signal, a receiver to demodulate and decode a received signal, and the like. Here, the data processing unit 115 may be configured to include a modem and a codec. The codec may include a data codec to process packet data and the like, and may include an audio codec to process an audio signal such as a voice and the like.

The audio processing unit 117 may play back, through a speaker, a reception audio signal output from the data processing unit 115, or may transmit a transmission audio signal generated from a microphone to the data processing unit 115. The key input unit 107 may include keys for inputting number and character information, and functional keys for setting varied types of functions.

The display unit 105 may display an image signal on a screen, and may display data requested by the controller 101. When the display unit 105 is embodied by a touch display screen, for example, a capacitive touch screen, a resistive touch screen, or the like, the key input unit 107 may include predetermined keys at the minimum, and the display unit 105 may be substituted for a part of a key input function of the key input unit 107.

Referring to FIG. 2, the display unit 105 may include an active matrix organic light-emitting diode (AMOLED) 201 and a liquid crystal display (LCD) controller 203.

The AMOLED 201 may display an image or a moving picture in response to a request from the controller 101 for displaying the image or the moving picture. The LCD controller 203 may calculate a color rate associated with the image or the moving picture displayed on the AMOLED 201, and may output the calculated color rate to the controller 101. For example, the LCD controller 203 may be embodied as an LCD display integrated circuit (IC). The display unit 105 including the AMOLED 201 may include the LCD display IC in advance, and the LCD display IC may calculate the color rate of the image.

Here, the color rate may correspond to a percent ratio of pixels for each color included in the image. For example, when 80% of the entire pixels of the image displayed on the AMOLED 201 are a white color, and 20% of the entire pixels are a black color, the LCD controller 203 may output, to the controller 101, a color rate indicating that the white color occupies 80% of the displayed image and the black color occupies 20% of the displayed image.

The battery 109 may output, to the controller 101, a current battery voltage value in response to a request from the controller 101 or at predetermined intervals. Here, the predetermined interval may be 5 seconds, for example.

The memory 111 may include a program memory and a data memory. Here, the program memory may store a boot and operating system (OS) for controlling a general operation of the portable terminal, and the data memory may store various data generated while the portable terminal operates.

In particular, the memory 111 may store a voltage value consumed by a pixel for each color represented on the AMOLED 201.

For example, the memory 111 may store Table 1 as given below.

TABLE 1

| Color | Consumed voltage (mV) |
|---|---|
| White | 0.001 |
| Black | 0.0005 |
| Red | 0.0002 |

The memory 111 may store a battery level corresponding to an adjusted battery voltage value according to the teachings of the present invention. Here, battery levels may be used to indicate a residual quantity of a battery, and may be obtained by dividing, by a plurality of levels, a voltage range of the battery in which the portable terminal is operating.

For example, the memory 111 may store Table 2 as given below.

TABLE 2

| Range of battery voltage (V) | Battery level |
|---|---|
| 3.5-3.63 | 1 |
| 3.64-3.77 | 2 |
| 3.78-3.91 | 3 |
| 3.92-4.05 | 4 |
| 4.06-4.2 | 5 |

The controller 101 may control an overall operation of the portable terminal. In particular, a power managing unit 103 of the controller 101 (1) may perform compensation to adjust a battery voltage value based on the color rate received from the LCD controller 203 and the current battery voltage value received from the battery 109, (2) may determine a battery level based on the adjusted battery voltage value, and (3) may change a battery residual quantity icon displayed on the display unit 105 based on the determined battery level.

Here, the battery residual quantity icon, indicating a residual quantity of a battery, may be displayed on an upper portion of the display unit 105. For example, when the battery level is ‘1’, the controller 101 may change the battery residual quantity icon so as to display a battery residual quantity corresponding to the battery level of ‘1’.

When a request for displaying an image is input according to a first embodiment of the present invention, the controller 101 may display the image on the display unit 105. The controller 101 may receive a color rate associated with the displayed image from the display unit 105, and may receive a current battery voltage value from the battery 109. In this example, the controller 101 may receive the current battery voltage value based on an analog scheme, and may convert the analog current battery voltage value into a digital value through use of a analog-to-digital converter (ADC) (not illustrated) of the controller 101.

For example, when 80% of the displayed image is a white color and 20% of the displayed image is a black color, the controller 101 may receive a color rate indicating that the white color occupies 80% of the displayed image and the black color occupies 20% of the displayed image.

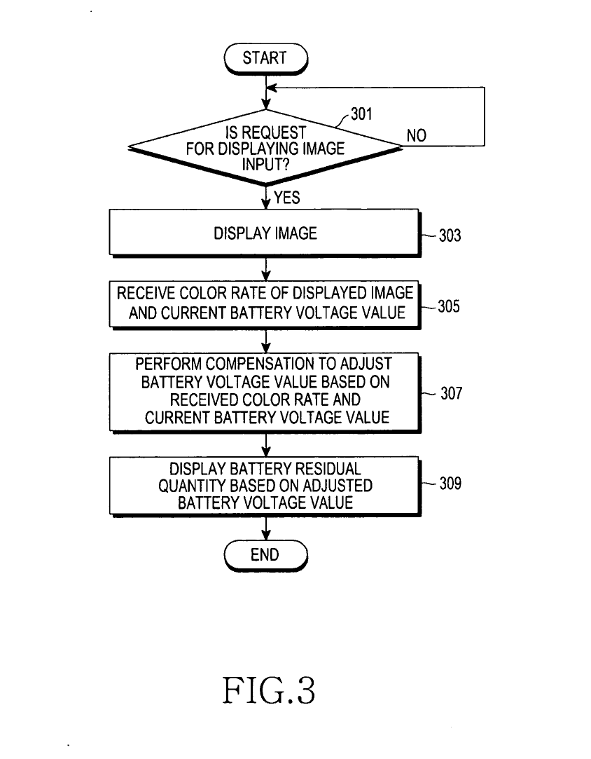

The controller 101 may apply the received color rate and the current battery voltage value to a battery voltage compensation algorithm so as to adjust a battery voltage value. Here, the battery voltage compensation algorithm may correspond to an algorithm that compensates for a temporary voltage drop of the battery caused by execution of a predetermined application or display of an image on the AMOLED 201. A detailed explanation of the battery voltage compensation algorithm is explained with reference to FIG. 3.

As another example, when a request for executing an application that displays an image is input by a user according to a first embodiment of the present invention, the controller 101 may execute the corresponding application. Here, the application may refer to an application that displays an image on the display unit 105 when the application is executed. For example, the application displaying an image may include a camera application, a game application, a map application, a moving picture execution application, and the like.

The controller 101 may receive a color rate associated with the displayed image from the display unit 101, and may receive a current battery voltage value from the battery 109. In this example, the controller 101 may receive the current battery voltage value based on an analog scheme, and may convert the analog current battery voltage value into a digital value through use of an ADC (not illustrated) of the controller 101.

For example, when 80% of the displayed image is a white color and 20% of the displayed image is a black color, the controller 101 may receive a color rate indicating that the white color occupies 80% of the displayed image and the black color occupies 20% of the displayed image.

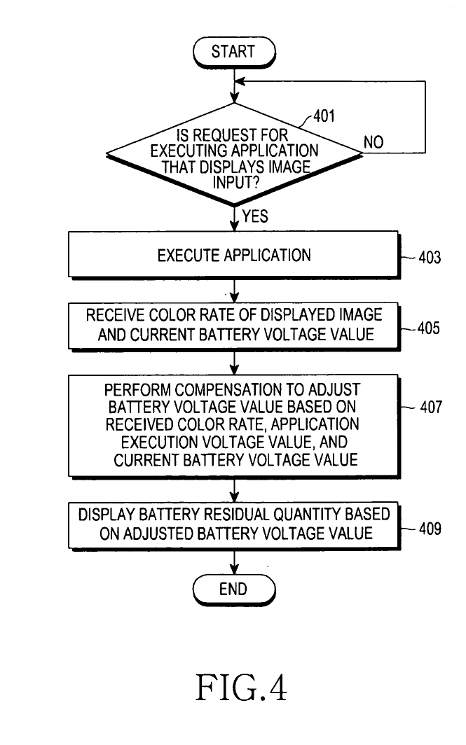

The controller 101 may apply, to a battery voltage compensation algorithm, the received color rate, the current battery voltage, and an application execution voltage value, so as to adjust a battery voltage value. Here, the application execution voltage value corresponds to a voltage value consumed from the battery 109 while a predetermined application is executed. The application execution voltage value may be determined by the controller 101 through measuring a variance in voltage of the battery 109, or may be stored in advance in the memory 111 for each application. A detailed explanation of the battery voltage compensation algorithm is explained with reference to FIG. 4.

FIG. 3 illustrates a method of performing compensation to adjust a battery voltage in a portable terminal according to a first exemplary embodiment of the present invention.

Referring to FIG. 3, the controller 101 may determine whether a request for displaying an image is input by a user or by a predetermined operation of an application in operation 301. When the request is input, the controller 101 may proceed with operation 303. Otherwise, operation 301 is iteratively performed. In operation 303, the controller 101 may display the corresponding image, and may proceed with operation 305.

In operation 305, the controller 101 may receive a color rate associated with the displayed image, may receive a current battery voltage value, and may proceed with operation 307. In this example, the controller 101 may receive the current battery voltage value based on an analog scheme, and may convert the analog current battery voltage value into a digital value through use of an ADC (not illustrated) of the controller 101.

For example, when 80% of the displayed image is a white color and 20% of the displayed image is a black color, the controller 101 may receive a color rate indicating that the white color occupies 80% of the displayed image and the black color occupies 20% of the displayed image.

In operation 307, the controller 101 may apply the received color rate and the current battery voltage value to a battery voltage compensation algorithm, so as to adjust a battery voltage value, and then may proceed with operation 309. Here, the battery voltage compensation algorithm may correspond to an algorithm that compensates for a temporary voltage drop of a battery caused by execution of a predetermined application or display of an image on the AMOLED 201.

For example, when a total number of pixels is 384,000, the color rate indicates that a white color occupies 80% of the displayed image and a black color occupies 20% of the displayed image, and the current battery voltage value is 3.6V, the controller 101 current battery voltage value, and may proceed with operation 407. In this example, the controller 101 may receive the current battery voltage value based on an analog scheme, and may convert the analog current battery voltage value into a digital value through use of an ADC (not illustrated) of the controller 101.

For example, when 80% of the displayed image is a white color and 20% of the displayed image is a black color, the controller 101 may receive a color rate indicating that the white color occupies 80% of the displayed image and the black color occupies 20% of the displayed image.

In operation 407, the controller 101 may apply the received color rate, the current battery voltage value, and an application execution voltage value to a battery voltage compensation algorithm, so as to adjust a battery voltage value, and then may proceed with operation 409. Here, the application execution voltage value corresponds to a voltage value consumed from the battery 109 while a predetermined application is executed. The application execution voltage value may be determined by the controller 101 through measuring a variance in voltage of the battery 109, or may be stored in advance in the memory 111 for each application.

For example, when a total number of pixels is 384,000, the color rate indicates that 80% of the displayed image is a white color and 20% of the displayed image is a black color, the application execution voltage value of the application executed in operation 403 is 0.02 V, and the current battery voltage value is 3.6 V, the controller 101 may calculate a voltage value of 0.307 V consumed for representing the white color, by multiplying a number of pixels representing the white color, that is, 307,200, by a per-pixel voltage value of 0.001 mV for the white color as given in Table 1. The controller 101 may calculate a voltage value of 0.038 V consumed for representing the black color, by multiplying a number of pixels representing the black color, that is, 76,800, by a per-pixel voltage value of 0.0005 mV for the black color as given in Table 1. The controller 101 may calculate a voltage value of 0.345 V consumed for displaying the image by adding the voltage value of 0.307 V consumed for representing the white color and the voltage value of 0.038 V consumed for representing the black color. The controller 101 may determine the adjusted battery voltage value of 3.965 V by adding the calculated voltage value 0.345 V, the application execution voltage value of 0.02 V, and the current battery voltage value of 3.6 V.

In operation 409, the controller 101 may display a battery residual quantity based on the adjusted battery voltage value. For example, when the adjusted battery voltage value is 3.965 V, the controller 101 may detect a battery level of ‘4’ corresponding to the adjusted battery voltage value from Table 2 stored in the memory 111, and may change a battery residual quantity icon displayed on the display unit 105 so as to display the battery residual quantity corresponding to the detected battery level of ‘4’.

As described in the foregoing, the exemplary embodiments may provide an effect of adjusting a battery voltage level output associated with a color through use of a currently included LCD display IC, as opposed to using a dedicated gauge IC.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for adjusting a battery voltage level output in a portable terminal, comprising:
a display unit including an active matrix organic light-emitting diode (AMOLED) that displays an image and calculates a color rate of the image;
a battery outputting a current battery voltage value at predetermined intervals; and
a controller to receive the color rate of the image and the current battery voltage value when the image is displayed, to adjust a battery voltage value based on the current battery voltage value, and to change a battery residual quantity icon indicating a residual quantity of the battery based on the adjusted battery voltage value.

2. The apparatus of claim 1, wherein the display unit comprises a liquid crystal display (LCD) integrated circuit (IC) to calculate the color rate of the image.

3. The apparatus of claim 1, wherein the color rate corresponds to a value obtained by dividing a number of pixels for each color included in the image by a total number of pixels.

4. The apparatus of claim 1, wherein the controller calculates a voltage value consumed in the AMOLED based on the color rate of the image, and determines the adjusted battery voltage value by adding the calculated voltage value and the current battery voltage value.

5. The apparatus of claim 1, wherein the controller executes an application to display the image when the execution of the application is requested, and performs the adjustment of the battery voltage value based on the color rate of the image, the current battery voltage value, and an application execution voltage value indicating a voltage value consumed while the application is executed.

6. The apparatus of claim 5, wherein the controller calculates a voltage value consumed in the AMOLED based on the color rate of the image, and determines the adjusted battery voltage value by adding the calculated voltage value, the current battery voltage value, and the application execution voltage value.

7. A method for adjusting a battery voltage level output in a portable terminal, the method comprising:
calculating a color rate of an image when the image is output on an active matrix organic light-emitting diode (AMOLED);
determining a current battery voltage value;
adjusting a battery voltage value based on the color rate of the image and the current battery voltage value; and
changing a battery residual quantity icon indicating a residual quantity of a battery based on the adjusted battery voltage value.

8. The method of claim 7, wherein the color rate of the image is calculated by a liquid crystal display (LCD) integrated circuit (IC).

9. The method of claim 7, wherein the color rate corresponds to a value obtained by dividing a number of pixels for each color included in the image by a total number of pixels.

10. The method of claim 7, wherein the adjusting the battery voltage value comprises:
calculating a voltage value consumed by the AMOLED based on the color rate of the image; and
determining the adjusted battery voltage value by adding the calculated voltage value and the current battery voltage value.

11. The method of claim 7, wherein the adjusting the battery voltage value comprises:
executing an application to display the image when the execution of the application is requested; and
adjusting the battery voltage value based on the color rate of the image, the current battery voltage value, and an application execution voltage value indicating a voltage value consumed while the application is executed.

12. The method of claim 11, wherein the adjusting the battery voltage value comprises:
calculating the voltage value consumed by the AMOLED based on the color rate of the image; and
determining the adjusted battery voltage value by adding the calculated voltage value, the current battery voltage, and the application execution voltage value.

13. A method for adjusting a battery voltage level output in a portable terminal, the method comprising:
calculating a color rate of an image when the image is output on an active matrix organic light-emitting diode (AMOLED);
determining a current battery voltage value;
adjusting a battery voltage value based on the color rate of the image and the current battery voltage value; and
displaying a battery residual quantity icon indicating a residual quantity of a battery based on the adjusted battery voltage value.

14. The method of claim 13, wherein the color rate of the image is calculated by a liquid crystal display (LCD) integrated circuit (IC).

15. The method of claim 13, wherein the color rate corresponds to a value obtained by dividing a number of pixels for each color included in the image by a total number of pixels.

16. The method of claim 13, wherein the adjusting the battery voltage value comprises:
calculating a voltage value consumed by the AMOLED based on the color rate of the image; and
determining the adjusted battery voltage value by adding the calculated voltage value and the current battery voltage value.

17. The method of claim 13, wherein the adjusting the battery voltage value comprises:
executing an application to display the image when the execution of the application is requested; and
adjusting the battery voltage value based on the color rate of the image, the current battery voltage value, and an application execution voltage value indicating a voltage value consumed while the application is executed.

18. The method of claim 13, wherein the adjusting the battery voltage value comprises:
calculating the voltage value consumed by the AMOLED based on the color rate of the image; and
determining the adjusted battery voltage value by adding the calculated voltage value, the current battery voltage, and the application execution voltage value.
